(19) United States
(12) Patent Application Publication
(10) Pub. No.: US 2026/0321766 A1
(43) Pub. Date: Oct. 15, 2026

(54) BATTERY FOR CORDLESS OUTDOOR PRODUCTS

(71) Applicant: SharkNinja Operating LLC, Needham, MA (US)

(72) Inventor: Hanning TANG, Belmont, MA (US)

(21) Appl. No.: 19/179,710

(22) Filed: Apr. 15, 2025

(51) Int. Cl. H01M 10/615; H01M 10/42; H01M 10/48; H01M 10/6235; H01M 10/633; H01M 10/6571; H02J 7/00

(52) U.S. Cl. CPC H01M 10/615; H01M 10/4257; H01M 10/482; H01M 10/486; H01M 10/6235; H01M 10/633; H01M 10/6571; H02J 7/977; H01M 2010/4271; H01M 2220/30

(57) ABSTRACT

The present disclosure is directed to a heating system for a battery assembly configured to power a cordless electric tool. In some embodiments, the heating system includes a temperature sensor configured to output one or more signals corresponding to a temperature of one or more cells of the battery assembly, a heater configured to heat the one or more cells, and a battery management system configured to determine the temperature of the one or more cells. In some embodiments, the one or more cells are configured to power the heater. In some embodiments, the battery management system is configured to activate the heater when the temperature of the one or more cells is less than a temperature threshold.

### FIELD

The present disclosure is directed to a battery assembly, and more specifically a battery assembly with a heater to warm a battery for cordless outdoor products.

### BACKGROUND

Batteries power various electric devices, including cordless electric tools, such as blowers and chainsaws. These electric devices may be exposed to cold environments (e.g., below 0 °Celsius). The internal chemistry of batteries may prevent effective and safe charging in cold environments.

### SUMMARY

The present disclosure describes battery and heating systems configured to warm a battery assembly for a cordless electric tool. In some embodiments, the battery assembly includes cells. In some embodiments, the heating system includes a heater powered by the battery assembly, and configured to warm the cells to a predetermined temperature. In some embodiments, a battery management system is configured to control current flowing from the battery cells to the heater, and to control current flowing from a charger to the battery cells. The battery and heating systems disclosed herein can be used in a variety of cordless electrical tools including, but not limited to, blowers (e.g., leaf blowers, snow blowers), chainsaws (e.g., sliding miter saws), drills, lawn mowers, hedge trimmers, string trimmers, edgers, and pressure washers.

In some embodiments, the heating system includes a temperature sensor configured to output one or more signals corresponding to a temperature of one or more cells of the battery assembly, a heater configured to heat the one or more cells, and a battery management system configured to determine the temperature of the one or more cells. In some embodiments, the one or more cells are configured to power the heater. In some embodiments, the battery management system is configured to activate the heater when the temperature of the one or more cells is less than a temperature threshold.

In some embodiments, the battery management system is configured to prevent the one or more cells from charging when the temperature of the one or more cells is less than the temperature threshold. In some embodiments, the battery management system is configured to allow the one or more cells to charge when the temperature of the one or more cells is greater than or equal to the temperature threshold.

In some embodiments, the heater comprises a resistive heating element spaced less than 3 inches from an exterior surface of the one or more cells. In some embodiments, the resistive heating element is in direct contact with the exterior surface of the one or more cells. In some embodiments, the battery assembly includes a case enclosing the one or more cells, and at least a portion of the resistive heating element is disposed inside the case. In some embodiments, the battery assembly includes a case enclosing the one or more cells, and at least a portion of the resistive heating element is embedded in a perimeter wall of the case. In some embodiments, the resistive heating element is formed from a material that has a resistivity that is less than or equal to 10-7 Ω·M at 20 °C.

In some embodiments, the battery assembly, the heater, and the battery management system are disposed inside a battery pack, and the battery pack is configured to be removably coupled to the cordless electric tool

In some embodiments, a first signal of the one or more signals corresponding to a temperature of the one or more cells corresponds to a temperature of the coldest cell of the one or more cells. In some embodiments, a second signal of the one or more signals corresponding to a temperature of the one or more cells corresponds to a temperature of the hottest cell of the one or more cells.

In some embodiments, the present disclosure includes a charging system for a cordless electric tool. In some embodiments, the charging system includes a battery assembly including one or more cells and configured to power the cordless electric tool. In some embodiments, the charging system includes a heating system that includes a temperature sensor configured to output a signal corresponding to a temperature of the one or more cells, and a battery management system configured to determine the temperature of the one or more cells. In some embodiments, the charging system includes a charger configured charge the one or more cells. In some embodiments, the one or more cells are configured to power the heater. In some embodiments, the battery management system is configured to prevent the one or more cells from charging when the temperature of the one or more cells is less than a first temperature threshold, and the battery management system is configured to activate the heater when the temperature of the one or more cells is less than the first temperature threshold.

In some embodiments, the battery management system charges the one or more cells at a first rate when the temperature of the one or more cells is between greater than or equal to the first temperature threshold and less than a second temperature threshold. In some embodiments, the battery management system charges the one or more cells at a second rate when the temperature of the one or more cells is greater than or equal to the second temperature threshold. In some embodiments, the first rate is less than or equal to 1 Amp, and the second rate is greater than or equal to 3 Amps. In some embodiments, the first temperature threshold is greater than or equal to 0 °C. In some embodiments, the first temperature threshold is greater than or equal to 10 °C.

In some embodiments, the charging system includes an ambient temperature sensor configured to output a signal corresponding to an ambient temperature. In some embodiments, the battery management system is configured to determine the temperature of the one or more cells based on the ambient temperature.

In some embodiments, the battery management system is configured to determine the temperature of the one or more cells based on a thermal model. In some embodiments, the battery management system is configured to adjust the temperature threshold based on a heating rate of the one or more cells

### BRIEF DESCRIPTION OF THE DRAWINGS/FIGURES

FIG. 1 is a system diagram of a charging system according to an embodiment;

FIG. 2 is a circuit diagram of a charging system according to an embodiment;

FIG. 3 is a block diagram of a charging system according to an embodiment;

FIG. 4 is a block diagram of a charging system according to an embodiment;

FIG. 5A is a system diagram of a heating system according to an embodiment;

FIG. 5B is a system diagram of heating system according to an embodiment;

FIG. 6 is a system diagram of a heating system according to an embodiment;

FIG. 7 is a flowchart of a heating method according to an embodiment; and

FIG. 8 is a flowchart of a heating method according to an embodiment.

### DETAILED DESCRIPTION

Batteries, for example lithium batteries, are widely used in indoor home appliances because they are highly reliable, affordable, and typically have high power density. However, lithium batteries demonstrate diminishing performance (e.g., charging and discharging rate) in cold environments (e.g., below 0 °Celsius). For example, users of cordless electric tools, such as a snow blower or chainsaw, may bring the battery, or the entire tool, indoors for efficient and safe charging. This can be inconvenient, where, for example, users are not near their home or do not have a heated garage. Charging lithium batteries that are below, for example, −20 °Celsius, can reduce the battery's life span (e.g., capacitance) over successive charging cycles.

The present disclosure includes battery heating systems configured to warm a battery assembly. Warming the battery assembly can mitigate reductions in capacitance over cyclical charging and discharging, without increasing the charging time in a manner that impacts the user experience. The heating systems disclosed herein can have a low size, weight, and power (SWaP) relative to the battery power and capacitance, as compared to battery heating systems found in, for example, electric automobiles. As discussed in more detail below, the low SWaP heaters disclosed herein can warm the battery assembly without significantly impacting the weight or cost of the cordless electric tool.

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1-15% of the value (e.g., ±1%, ±2%, ±5%, ±10%, or ±15% of the value). The term “between” as used herein, indicates an inclusive range.

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

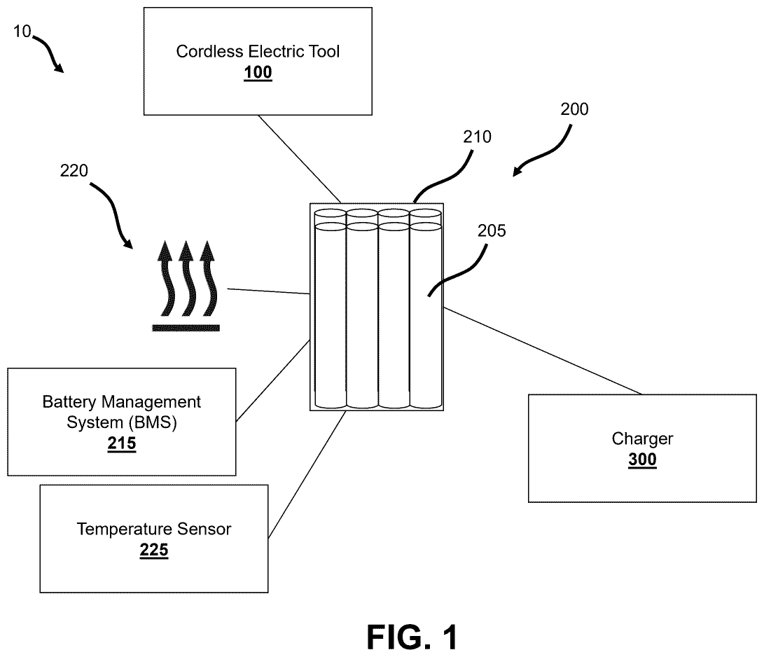

In some embodiments, as shown for example in FIG. 1, a charging environment 10, includes a cordless electric tool 100, a battery assembly 200, a heater 220, and a charger 300. In some embodiments, battery assembly 200 includes a case 210 and one or more cell(s) 205 disposed within case 210. In some embodiments, a battery management system 215 is configured to, for example, control current between charger 300 and battery assembly 200 and/or between battery assembly 200 and heater 220. In some embodiments, battery management system 215 includes, for example, a printed circuit board (PCB). The printed circuit board can control heating and charging of battery assembly 200, by, for example, determining cell 205 temperature(s), comparing cell 205 temperatures to a threshold temperature, turning heater 220 on or off, and closing or opening the charging switch to allow or prevent charging, respectively. In some embodiments, a temperature sensor 225 is connected to one or more cells 205 and is configured to output a signal corresponding to the temperature of one or more cells 205 to battery management system 215. In some embodiments, temperature sensor 225 includes one or more sensors. In some embodiments, battery management system 215 is configured to receive a signal corresponding to the temperature of one or more cells 205.

In some embodiments, battery assembly 200 includes multiple temperature sensors 225 configured to output the temperature of one or more cells 205. In some embodiments, battery assembly 200 includes a temperature sensor configured to output an ambient temperature.

In some embodiments, battery assembly 200 has a voltage between 10 and 120 volts. In some embodiments, battery assembly 200 has a voltage less than 100 volts, less than 80 volts, less than 60 volts, less than 40 volts, or less than 20 volts. In some embodiments, battery assembly 200 has a capacitance between 1 Amp-hour and 30 Amp-hours. In some embodiments, battery assembly 200 has a capacitance less than 25 Amp-hours, less than 20 Amp-Hours, less than 15 Amp-hours, less than 10 Amp-hours, or less than 5 Amp-hours. In some embodiments, battery assembly has a capacitance less than 8 Amp-hours, less than 6 Amp-hours, less than 4 Amp-hours, or less than 2 Amp-hours. In some embodiments, battery assembly 200 is configured to receive a charging current between 1 Amp and 8 Amps. In some embodiments, battery assembly 200 is configured to receive a charging current between 1 Amp and 4 Amps, or between 4 Amps and 8 Amps.

Relatively low charging rates (e.g., compared to for example, 40 Amps for a 30 Amp-hour battery in an electric vehicle) are adequate, because users do not typically plan to operate cordless electric tool 100 soon after (e.g., 30 minutes) draining the battery. By contrast, electric vehicles need batteries capable of charging at high rates so drivers minimize their time at, for example, a charging station. Accordingly, heater 220 (e.g., a low SWaP heater) can maintain acceptable charging times despite including heating time where battery assembly 200 is not charging. Although using low SWaP heater 220 may increase charging time, it should not impact user satisfaction with cordless electric tool 100. Specifically, increases in charging time introduced by low SWaP heater 220 do not impact the user experience because the charging time remains on the same order of magnitude as the charging time without heating. That is, users are unlikely to recognize an increased charging time if the charging time remains in hours, as opposed to, for example, minutes. By contrast, electric vehicle users accustomed to, for example, a 40-minute charge time, would more readily notice that their charging time increased to over an hour. In other words, any increase in charge time introduced by low SWaP heater 220 is a small portion of the standard charge time (e.g., without heating).

In some embodiments, battery assembly 200 charges in a normalized charging time that is less than 1.2, where the normalized charging time is the ratio between battery assembly 200 charging time, which includes heating time and charging time, and the standard calculated charging time (capacitance, Ah/charging rate, A) without heating. Battery assembly 200 charging time includes time spent heating cells 205 from −20 °Celsius, at an ambient temperature of −20 °Celsius, to a temperature threshold (e.g., safe charging temperature). In other words, the time it takes battery assembly 200 to heat (starting at a cell 205 temperature of −20 °Celsius, and an ambient temperature of −20 °Celsius) and completely charge is less than 120% (i.e., 20% slower) of the standard calculated charging time (i.e., without heating). In some embodiments, the normalized charging time is between 1 and 1.05, 1.05 and 1.1, 1.1 and 1.15, or between 1.15 and 1.2. In some embodiments, as discussed in detail below, the normalized charging time is between 0.9 and 1.1

In some embodiments, battery assembly 200 weighs less than 20 lbs. In some embodiments, battery assembly 200 weighs less than 15 lbs, less than 10 lbs, or less than 5 lbs. In some embodiments, battery assembly 200 weighs less than 8 lbs, less than 6 lbs, less than 4 lbs, or less than 2 lbs. Because users typically carry cordless electric tool 100 (e.g., chainsaw, snow blower, power drill), increases in battery assembly 200 weight can negatively impact user experience. Although low SWapP heater 220 may increase charging time, it maintains the weight of cordless electric tool 100 absent heater 220.

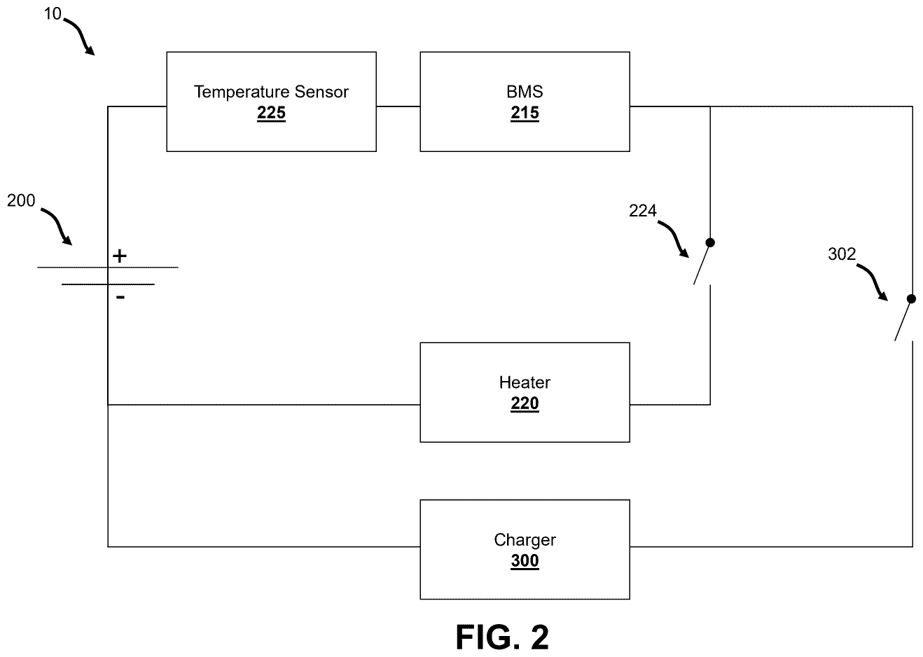

In some embodiments, as shown for example in FIG. 2, heater 220 is electrically connected to battery assembly 200 such that current can flow from battery assembly 200 to heater 220. In some embodiments, cells 205 can safely discharge at lower temperatures than are safe for charging. For example, in some embodiments, cells 205 are manufactured to charge at temperatures greater than or equal to 0 °Celsius, but can safely discharge at temperatures as low as −20 °Celsius. Powering heater 220 by battery assembly 200 facilitates warming battery assembly 200 independently of power supplied by charger 300, and leverages the characteristics of battery assembly's 200 internal chemistry (e.g., difference between discharge and charging temperatures). In some embodiments, battery assembly 200 is more effective at powering heater 220 than charger 300 is. In some embodiments, for example, battery assembly 200 has a higher power density than charger 300. In some embodiments, battery assembly 200 provides instantaneous power to heater 220 that is 5-15 times greater than the instantaneous power charger 300 can provide to heater 220. For example, in some embodiments charger 300 is designed (e.g., lower power density than battery assembly 200) to supply power to battery assembly 200, but is not configured to also supply sufficient power to operate heater 220.

In some embodiments, battery management system 215 is electrically connected to heater 220, cells 205, and temperature sensor 225. In some embodiments, battery management system 215 is electrically connected to charger 300. For example, battery management system 215 can be configured to control (e.g., allow, throttle, stop) current between charger 300 and battery assembly 200 and current between battery assembly 200 and heater 220.

In some embodiments, as shown for example in FIG. 2, battery management system 215 is configured to toggle a heating switch 224 and/or a charging switch 302. For example, if the temperature of battery assembly 200 is below a threshold temperature, battery management system 215 can close heating switch 224, allowing current to flow between battery assembly 200 and heater 220. In turn, heater 220 can warm battery assembly 200 until it reaches the temperature threshold. If battery assembly 200 reaches the temperature threshold, heater 220 can open heating switch 224 and close charging switch 302, to allow current to flow between charger 300 and battery assembly 200. In some embodiments, heating switch 224 and/or charging switch 302 are field-effect transistors (e.g., MOSFET). Heating switch 224 and charging switch 302 can be any type of switch operable to toggle current between charger 300 and battery 200, and between battery 200 and heater 220.

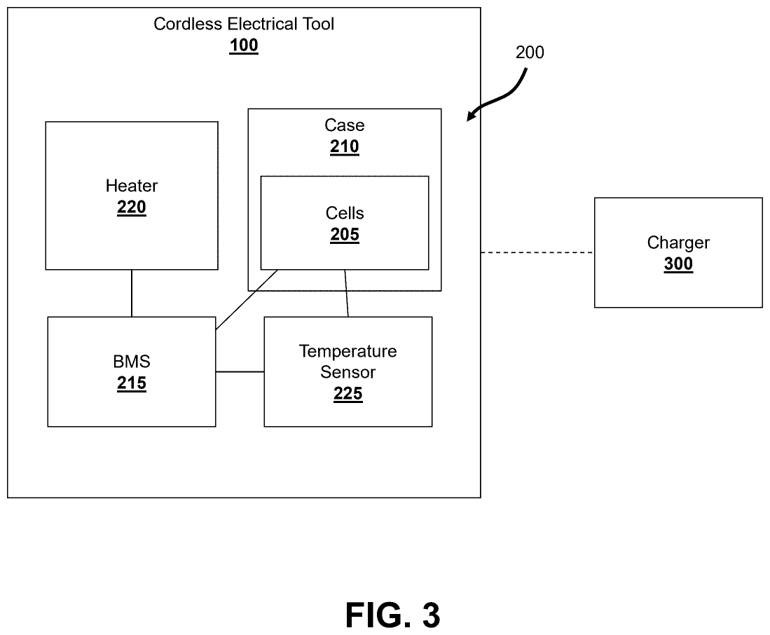

In some embodiments, as shown for example in FIG. 3, battery assembly 200 is disposed inside cordless electric tool and battery assembly 200 is not removable. For example, in some embodiments, battery assembly 200 remains inside cordless electric tool 100 when cordless electric tool 100 connects to charger 300, and users cannot readily remove (e.g., without tools) battery assembly 200.

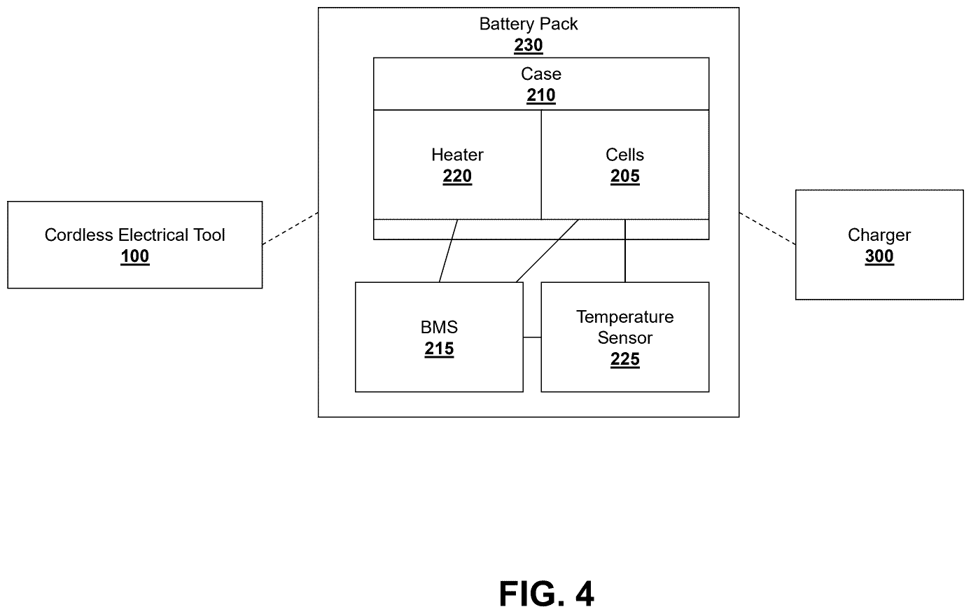

In some embodiments, as shown for example in FIG. 4, battery assembly 200 is disposed inside a battery pack 230 that is configured to removably couple to cordless electric tool 100 and charger 300. In some embodiments, cells 205, case 210, battery management system 215, and/or temperature sensor 225 are disposed inside battery pack 230.

In some embodiments, as shown for example in FIGS. 3-4, battery assembly 200 includes a case 210 around cells 205. In some embodiments, case 210 is, for example, a Polyvinyl chloride (PVC) wrap (e.g., shrink wrap). In some embodiments, case 210 is, for example, formed from a hard plastic.

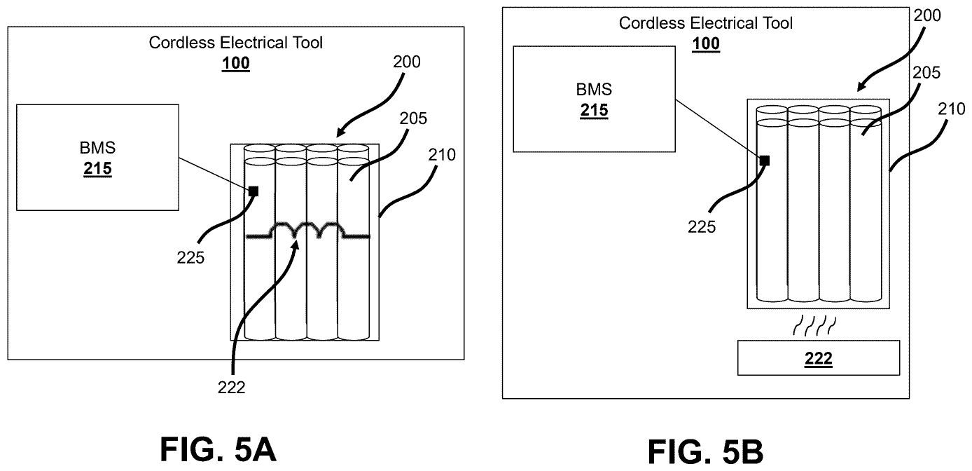

In some embodiments, as shown for example in FIGS. 5A-5B, battery assembly is disposed inside cordless electric tool 100 and is not removable (as discussed above), and heater 220 includes a heating element 222 inside cordless electric tool 100. In some embodiments, heating element 222 includes one or more elements (e.g., coils, space heaters, etc.) In some embodiments, as shown for example in FIG. 5A, heating element 222 is in direct contact with one or more cells 205. For example, in some embodiments, heating element 222 is a coil wrapped around cells 205. Direct contact between heating element 222 and cells 205 can provide for simple and low-cost integration of heater 220 into battery assembly 200 where, for example, battery assembly 200 is not removable and therefore the visual appearance of battery assembly 200 is hidden. In some embodiments, direct contact (e.g., wrapping) between heating element 222 and cells 205 mitigates size/volume constraints on battery assembly 200 because heating element 222 mounts directly to the exterior of cells 205, as opposed to a separate mounting location inside cordless electric tool 100.

In some embodiments, as shown for example in FIG. 5B, heating element 222 is spaced from cells 205. In some embodiments, heating element 222 is, for example, a positive-temperature-coefficient (PTC) space heater. In some embodiments, heating element 222 is approximately between 0.5 inches and 3 inches from the exterior of battery cells 205. In some embodiments, heating element 222 is spaced between 1 inch and 3 inches from the exterior of cells 205. In some embodiments, heating element 222 is spaced between 2 inches and 3 inches from the exterior of cells 205. A spaced relationship between heating element 222 and cells 205 can, for example, uniformly heat cells 205. A spaced relationship between cells 205 and heating element 222 can reduce manufacturing complexity by positioning heating element 222 within easily accessible (e.g., by a human hand) areas inside cordless electric tool 100.

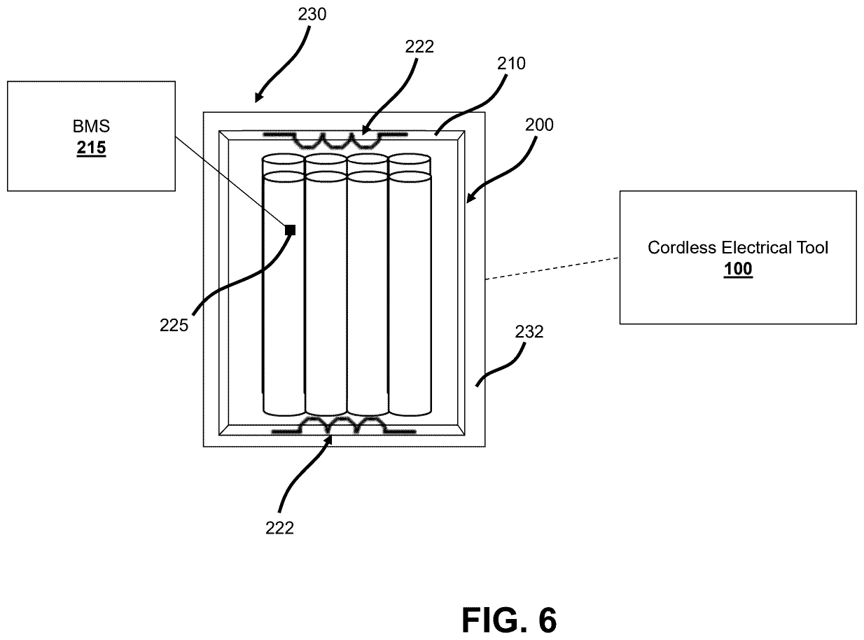

In some embodiments, as shown for example in FIG. 6, heater 220 includes a heating element 222 embedded within case 210. Embedding heating element 222 within case 210 can mitigate an increase in battery assembly 200 volume. For example, embedding heating element 222 inside walls of case 210 may thicken case 210 (relative to a case without an embedded heating element), but the increased thickness can have a smaller impact on battery assembly 200 volume than expanding case 210 internal volume to accommodate heating element 222 and associated mounting features.

Although FIGS. 5A-6 illustrate battery assembly 200 in removable or non-removable configurations, the configurations of heating element 222 relative to, for example, cells 205, disclosed herein can apply to both a removable and non-removable configuration. In some embodiments, for example, cells 205 are embedded in case 210 in a non-removable configuration. In some embodiments, case 210 isolates cells 205 from potential damage (e.g., water leaking from a pump inside a pressure washer) in both non-removable and removable configurations.

In some embodiments, as shown for example in FIG. 6, battery pack 230 includes insulation 232 so that, for example, a user can comfortably hold or touch battery pack 230 when heating element 222 is powered. In some embodiments, insulation 232 includes one or more materials to absorb heat. For example, in some embodiments, insulation 232 includes rubber, foam, plastic, and/or any other material to insulate the exterior of battery assembly 200 (e.g., in contact with a user's hand) from heat produced by heater 220.

In some embodiments, heating element 222 is made from a lightweight (e.g., atomic mass unit less than 80) and low resistivity metallic alloys, such as for example, copper (1.68×10⁻⁸ ω·m at 20 °C), Aluminum (2.65×10⁻⁸ Ω·m at 20 °C), Iron (9.71×10⁻⁸ Ω·m at 20 °C), or any combination thereof (e.g., Copper-Nickel alloy). A lightweight and low resistivity heating element 222 reduces the heater 220 power and conversely, demands on cells 205 to power heater 220, while also mitigating increases in cordless electric tool 100 weight.

For example, in some embodiments, heater 220 is configured to draw less than 2 Amps from cells 205. In some embodiments, heater is configured to draw less than 1.5 Amps, less than 1 Amp, or less than 0.5 Amps from cells 205. Even small changes in current draw can impact heater 220 power because power is directly related to current squared. Although it can take more time for a low power heater 220 to warm cells 205, increases in charging time will be practically inconsequential because, as discussed above, charging time remains within the same order of magnitude (e.g., hours, not tens of hours) such that it will not change the user experience.

In some embodiments, heating element 222 is made from a high resistivity material and/or metallic alloy, such as carbon fiber (between 2Ω·m and 20Ω·m at 20 °C), and Nichrome (1.5×10⁻⁶Ω·m at 20 °C). In some embodiments, heating element 222 is a metal ceramic heater (e.g., PTC heater packaged as a heating plate) made from high resistivity materials such as ceramic-metal composites. Heating element 222 made from high resistivity materials can output similar power (e.g., heat) relative to heating element 222 formed from low resistivity materials, because power is directly related to current squared and resistance. A higher resistance heating element 222 can output similar power as a lower resistance heating element 222 while drawing less current (e.g., lower voltage). Lower current draw (e.g., lower voltage) can mitigate increases in cordless electric tool 100 weight while producing sufficient heat to warm battery cells 205.

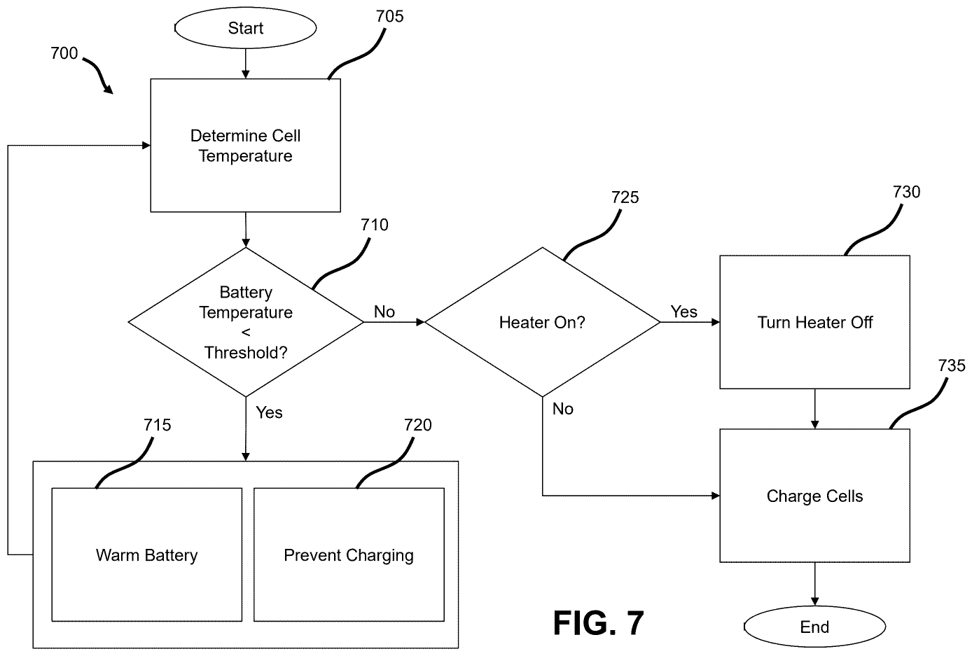

As discussed above, the elements discussed herein are operable to warm cells 205 so users can safely charge battery assembly 200 in cold environments, and can mitigate reductions in battery assembly 200 capacitance over charging cycles completed in cold environments. In some embodiments, as shown for example in FIG. 7, battery management system 215 is configured to execute a battery heating method 700. In some embodiments, battery heating method 700 initializes when, for example, battery assembly 200 is in electrical communication with charger 300.

In some embodiments, battery heating method 700 determines 705 cell 205 temperature. In some embodiments, battery management system 215 determines 705 cell 205 temperature based on a signal output by temperature sensor 225.

In some embodiments, for example, temperature sensor 225 outputs a signal to battery management system 215 corresponding to the average temperature of battery assembly 200, the exterior temperature of one or more cells 205 disposed in battery assembly 200, the ambient temperature, or any combination thereof.

For example, in some embodiments, temperature sensor 225 is configured to output the temperature of the coldest cell and/or the hottest cell of the one or more cells 205. For example, a heat map can identify which cells of the one or more cells 205 are typically the coldest and hottest. During, for example, assembly of battery pack 230 or cordless electric tool 100, temperature sensor 225 can be connected to the coldest cell and/or the hottest cell (based on the heat map) of the one or more cells 205.

In some embodiments, battery management system 215 includes a thermal model that dynamically estimates the average cell temperature and/or the temperature of each individual cell of the one or more cells 205. In some embodiments, the thermal model includes, for example, a Kalman filter, a Markov process, and/or uncertainty models (e.g., Gaussian, non-linear) to estimate the cell temperature of one or more cells 205. In some embodiments, battery management system 215 compares estimated temperatures from a thermal model, a heat map, signals from temperature sensors 225 corresponding to exterior cell temperature and/or ambient temperature, or any combination thereof. Accurately determining 705 the temperature of one or more cells 205 can mitigate premature heating and/or charging that can contribute to decreased battery capacitance and life span over charging cycles.

In some embodiments, battery management system 215 determines 710 if cell 205 temperature is below a predetermined temperature threshold. If battery assembly 200 temperature is below a predetermined temperature threshold, heater 220 warms 715 cells 205 and/or prevents 720 charging.

The threshold temperature can correspond to, for example, a minimum cell temperature for charging. In some embodiments, the threshold temperature is 0 °Celsius. In some embodiments, the threshold temperature is between −20 °Celsius and 10 °Celsius. In some embodiments, the threshold temperature is between −20 °Celsius and −15 °Celsius, −15 °Celsius and −10°Celsius, −10 °Celsius and −5 °Celsius, −5 °Celsius and 0 °Celsius, 0 °Celsius and 5 °Celsius, or 5 °Celsius and 10 °Celsius. For example, some manufacturers suggest to avoid charging lithium batteries when cell 205 temperatures are below 0 °Celsius, and to avoid fast charging (e.g., 4 Amps) when cell 205 temperatures are below 10 °Celsius. Warming 715 battery assembly 200 to, for example 10 °Celsius, as opposed to the minimum manufacturer suggested temperature (e.g., 0 °Celsius) can facilitate earlier fast charging, thereby reducing overall charge time while mitigating impacts to battery assembly 200 life span and capacitance.

In some embodiments, battery management system 215 dynamically adjusts the temperature threshold based on, for example, the temperature of cells 205 when battery assembly 200 connects to charger 300 and/or ambient temperature. Dynamically adjusting the temperature threshold based on the starting temperature of cells 205 balances the work done by cells 205 to power heater 220, with charging time and battery health. In one example, the temperature of cells 205 is −20 °Celsius when battery assembly 200 connects to charger 300, and battery management system 215 sets the temperature threshold at 0 °Celsius. In another example, the temperature of cells 205 is −2 °Celsius when battery assembly 200 connects to charger 300, and battery management system 215 sets the temperature threshold at 10°Celsius.

In some embodiments, when cells 205 are extremely cold (e.g., below −15°Celsius), it is better for the long term health of cells 205 to warm to a low temperature threshold (e.g., 0 °Celsius) so that heater 220 does not continue drawing power from cells 205 and cells 205 can begin safely charging, even if at a low rate (e.g., 1 Amp.) In one example, cells 205 are moderately cold (e.g., −2 °Celsius), and cells 205 power heater 220 until the temperature of cells 205 reaches a fast-charging temperature threshold (e.g., 10 °Celsius). Because cells 205 had a higher initial temperature, cells 205 power heater 220 to a higher threshold temperature without negatively impacting the health of cells 205, and can then take advantage of a higher charge rate (e.g., 4 Amps) to reduce charging time.

In another example, the ambient temperature is moderately cold (e.g., 5 °Celsius), but cell 205 temperature is extremely cold (e.g., −20 °Celsius) (e.g., a user brought battery assembly 200 into a garage having an ambient temperature greater than the outside air temperature). Battery management system 215 can set the temperature threshold to 10 °Celsius even though cell 205 temperature is −20 °Celsius. By accounting for ambient temperature, battery management system 215 can select a temperature threshold that balances the work done by cells 205 to power heater 220 with charging time and battery health.

In some embodiments, battery management system 215 dynamically adjusts the threshold temperature during heating by considering, for example, the running time spent heating cells 205, the heating rate of cells 205, ambient temperature, divergence from thermal models, divergence from estimations (e.g., charge time, heat time), or any combination thereof. For example, in some embodiments, battery management system 215 sets the temperature threshold at a first value (e.g., 10 °Celsius) upon initialization, but adjusts the temperature threshold to a second value (e.g., 0 °Celsius) after a predetermined threshold time (e.g., 30 minutes) to balance work done by cells 205 to power heater 220 with charging time and battery health.

In some embodiments, if battery management system 215 determines 710 that cell 205 temperature is greater than or equal to a predetermined temperature threshold, battery management system determines 725 if heater 220 is on. If battery management system 215 determines 725 that heater 220 is on (e.g., closed heating switch 224), battery management system 215 turns off 730 the heater (e.g., opens heating switch 224), and allows (e.g., closes charging switch 302) charger 300 to charge 735 cells 205. If battery management system 215 determines 725 that heater 220 is off, battery management system 215 allows (e.g., close charging switch 302) charger 300 to charge 735 cells 205.

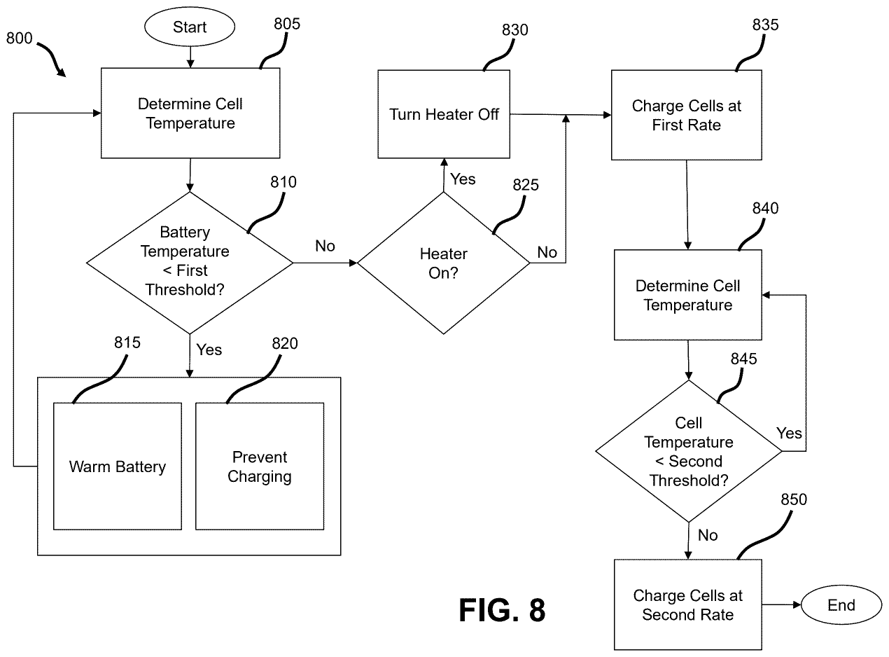

In some embodiments, as shown for example in FIG. 8, battery management system 215 is configured to execute a two-stage battery heating method 800. In some embodiments, cells 205 are configured to charge at a first rate and a second rate. In some embodiments, the first rate is less than or equal to 1 Amp. In some embodiments, the second rate is greater than or equal to 2 Amps. In some embodiments, the second rate is greater than or equal to 3 Amps.

In some embodiments, battery management system 215 determines 805 the temperature of one or more cells 205 based on a signal output by temperature sensor 225, as discussed above.

In some embodiments, battery management system evaluates 810 whether cell 205 temperature is below a first predetermined threshold. In some embodiments, the first predetermined temperature corresponds to a safe temperature for charging at a standard charging rate (e.g., 1 Amp). In some embodiments, the first temperature threshold is 0 °Celsius. In some embodiments, the first temperature threshold is between −20 °Celsius and −5 °Celsius. In some embodiments, the threshold temperature is between −20°Celsius and −15°Celsius, −15°Celsius and −10°Celsius, or −10°Celsius and −5°Celsius.

In some embodiments, if battery management system 215 evaluates 810 that cell 205 temperature is less than the first predetermined temperature threshold, heater 220 warms 815 cells 205 and/or battery management system 215 prevents 820 charging. In some embodiments, battery management system 215 continues to receive signals corresponding to the temperature of cells 205 and determines 805 cell 205 temperature.

In some embodiments, if battery management system 215 evaluates 810 that the temperature of cells 205 is greater than or equal to the first predetermined temperature threshold, battery management system 215 allows charger 300 to charge 835 cells 205 at a first rate (e.g., 1 Amp). Battery management system can allow charger 300 to charge 835 cells 205 at a first rate by, for example, toggling charging switch 302 closed and sending a signal to charger 300 to apply a predetermined charging current. In some embodiments, battery management system 215 evaluates 825 if heater 220 is on. If battery management system 215 evaluates 825 that heater 220 is off, battery management system 215 allows charger 300 to charge 835 cells 205 at a first rate. If battery management system 215 evaluates 825 that heater 220 is on, battery management system 215 turns off heater 220, and allows charger 300 to charge 835 cells 205 at a first rate. In some embodiments, even if battery management system 215 evaluates that cell 205 temperature is greater than or equal to a first temperature threshold and evaluates 825 that heater 220 is on, battery management system 215 keeps heater 220 on (e.g., does not open heating switch 224), so that heater 220 continues warming cells 205 while cells 205 charge at a first rate. For example, in some embodiments, keeping heater 220 on during charging allows cells 205 to charge while continuing to warm toward a second threshold temperature that is safe for charging at a higher rate (e.g., 4 Amps).

In some embodiments, while cells 205 charge 835 at a first rate, battery management system 215 continues to determine 840 the temperature of cells 205 and evaluates 845 the temperature of cells 205 against a second temperature threshold. In some embodiments, the second temperature threshold corresponds to a temperature at which fast charging (e.g., 4 Amps) is safe. In some embodiments, the second temperature threshold is 10 °Celsius. In some embodiments, the second temperature threshold is between −5 °Celsius and 20 °Celsius. In some embodiments, the second temperature threshold is between −5 °Celsius and 0 °Celsius, 0 °Celsius and 5 °Celsius, 5 °Celsius and 10 °Celsius, 10 °Celsius and 15 °Celsius, or 15 °Celsius and 20 °Celsius.

In some embodiments, if battery management system 215 evaluates 845 that the temperature of cells 205 is greater than or equal to the second temperature threshold, battery management system 215 allows cells 205 to charge 850 at a second rate (e.g., 4 Amps). Battery management system 215 can allow cells 205 to charge 850 at a second rate by, for example, sending a signal to charger 300 to increase the charging current to a predetermined charging current. If, for example, heater 220 remains on while cells 205 charge at a first rate (e.g., 1 Amp), battery management system 215 can turn heater 220 off if battery management system evaluates 845 that the temperature of cells 205 is greater than or equal to a second temperature threshold.

In some embodiments, battery assembly 200 charges in a similar or reduced time relative to a standard calculated charging time even though battery management system 215 prevents charging if cells 205 are below a temperature threshold. For example, in some embodiments, battery assembly 200 has a capacitance of 8 Amp-hours and is configured to charge at first rate of 1 Amp and a second rate of 4 Amps. Using a standard charge time calculation (capacitance/charging rate), it would take approximately 8 hours to charge an 8 Amp-hour battery assembly 200 completely at 1 Amp (i.e., 8 AH/1 A), and would take approximately 2 hours to charge an 8 Amp-hour battery assembly 200 completely at 4 Amps (i.e., 8 AH/4 A).

For example, in some embodiments, battery assembly 200 charges in a normalized charging time between 0.9 and 1.1. For example, in some embodiments, battery assembly 200 includes an 8 Amp-hour battery (e.g., cells 205), and is configured to charge at a first rate of 1 Amp, and a second rate of 4 Amps. In this example, the standard calculated charge rate is 8 hours. In some embodiments, it can take 8.4 hours to heat and charge cells 205, where the starting cell temperature is −20 °Celsius and the ambient temperature is −20 °Celsius, and thus the normalized charge time is 1.05 (i.e., 8.4 h/8 h).

In another example, battery assembly 200 includes an 10 Amp-hour battery (e.g., cells 205), and is configured to charge at a first rate of 1 Amp when cell 205 temperature is greater than or equal to 0 °Celsius, and a second rate of 4 Amps when cell 205 temperature is greater than or equal to 10 °Celsius. In this example, the standard calculated charge rate is 10 hours. In this example, cell 205 temperature increases from −20 °Celsius to 0 °Celsius in 4 hours, and battery assembly 200 begins charging at 1 Amp. In this example, battery assembly 200 charges at 1 Amp for 3.6 hours while cell 205 temperature increases from 0 °Celsius to 10 °Celsius, and then battery assembly 200 begins charging at 4 Amps. In this example, battery assembly 200 charges at 4 Amps for 1.6 hours until it is fully charged, and the total heating and charging time is 9.2 hours. In this example, the normalized charging time is 0.92.

As discussed above, charging time can be reduced by increasing heater 220 power, and conversely size and weight. A low SWaP heater 220, as discussed herein in combination with battery management system 215 and cells 205, maintains charging times in cold environments while protecting capacitance and battery health.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A heating system for a battery assembly configured to power a cordless electric tool, comprising:
a temperature sensor configured to output one or more signals corresponding to a temperature of one or more cells of the battery assembly;
a heater configured to heat the one or more cells; and
a battery management system configured to determine the temperature of the one or more cells,
wherein the one or more cells are configured to power the heater, and
wherein the battery management system is configured to activate the heater when the temperature of the one or more cells is less than a temperature threshold.

2. The heating system of claim 1, wherein the battery management system is configured to prevent the one or more cells from charging when the temperature of the one or more cells is less than the temperature threshold.

3. The heating system of claim 2, wherein the battery management system is configured to allow the one or more cells to charge when the temperature of the one or more cells is greater than or equal to the temperature threshold.

4. The heating system of claim 1, wherein the heater comprises a resistive heating element spaced less than 3 inches from an exterior surface of the one or more cells.

5. The heating system of claim 4, wherein the resistive heating element is in direct contact with the exterior surface of the one or more cells.

6. The heating system of claim 4, wherein the battery assembly comprises a case enclosing the one or more cells, and wherein at least a portion of the resistive heating element is disposed inside the case.

7. The heating system of claim 4, wherein the battery assembly comprises a case enclosing the one or more cells, and wherein at least a portion of the resistive heating element is embedded in a perimeter wall of the case.

8. The heating system of claim 4, wherein the resistive heating element is formed from a material that has a resistivity that is less than or equal to 10⁻⁷ Ω·m at 20 °C.

9. The heating system of claim 1, wherein the battery assembly, the heater, and the battery management system are disposed inside a battery pack, and wherein the battery pack is configured to be removably coupled to the cordless electric tool.

10. The heating system of claim 1, wherein a first signal of the one or more signals corresponding to a temperature of the one or more cells corresponds to a temperature of the coldest cell of the one or more cells, and wherein a second signal of the one or more signals corresponding to a temperature of the one or more cells corresponds to a temperature of the hottest cell of the one or more cells.

11. A charging system for a cordless electric tool, comprising:
a battery assembly comprising one or more cells and configured to power the cordless electric tool;
a heating system comprising:
a temperature sensor configured to output a signal corresponding to a temperature of the one or more cells, and
a battery management system configured to determine the temperature of the one or more cells; and
a charger configured charge the one or more cells,
wherein the one or more cells are configured to power the heater,
wherein the battery management system is configured to prevent the one or more cells from charging when the temperature of the one or more cells is less than a first temperature threshold, and
wherein the battery management system is configured to activate the heater when the temperature of the one or more cells is less than the first temperature threshold.

12. The charging system of claim 11, wherein the battery management system charges the one or more cells at a first rate when the temperature of the one or more cells is greater than or equal to the first temperature threshold and less than a second temperature threshold.

13. The charging system of claim 12, wherein the battery management system charges the one or more cells at a second rate when the temperature of the one or more cells is greater than or equal to the second temperature threshold.

14. The charging system of claim 13, wherein the first rate is less than or equal to 1 Amp, and the second rate is greater than or equal to 3 Amps.

15. The charging system of claim 11, wherein the first temperature threshold is greater than or equal to 0 °C.

16. The charging system of claim 15, wherein the first temperature threshold is greater than or equal to 10 °C.

17. The charging system of claim 11, further comprising an ambient temperature sensor configured to output a signal corresponding to an ambient temperature.

18. The charging system of claim 17, wherein the battery management system is configured to determine the temperature of the one or more cells based on the ambient temperature.

19. The charging system of claim 11, wherein the battery management system is configured to determine the temperature of the one or more cells based on a thermal model.

20. The charging system of claim 11, wherein the battery management system is configured to adjust the temperature threshold based on a heating rate of the one or more cells.
